(19) United States
(12) Patent Application Publication
(10) Pub. No.: US 2010/0314416 A1
(43) Pub. Date: Dec. 16, 2010

(54) Boxed Beverage Stand

(76) Inventor: Bryant S. Wezner, Blue Bell, PA (US)

Correspondence Address: HARSHAW RESEARCH, INC., 210 W. TECUMSEH STREET, OTTAWA, KS, 66067, US

(21) Appl. No.: 12/483,715

(22) Filed: Jun. 12, 2009

(51) Int. Cl. B67D 5/06; B67D 1/07

(52) U.S. Cl. 222/185.1; 222/192

(57) ABSTRACT

A boxed beverage stand for use with a boxed beverage having a container portion and a valve includes a lower portion having a plurality of legs, a top end, and an open area. The plurality of legs elevates the top end above the open area. The stand includes rails adjacent the lower portion top end forming a channel for receiving a glass. An upper portion is complementary to the lower portion top end for being selectively received atop the lower portion top end. The upper portion includes a floor, opposed sidewalls, a front wall, and a rear wall all extending upwardly from the floor and that define a receiving area configured to receive the boxed beverage container portion. The front wall includes a vertical passage for the boxed beverage valve to pass through when the boxed beverage container portion is in the receiving area.

### BACKGROUND OF THE INVENTION

This invention relates generally to beverage stands and dispensers and, more particularly, to a beverage stand for supporting and dispensing a boxed beverage and that includes structure for receiving glassware.

Beverages packaged in boxes, such as wine, have become popular and are often dispensed from a box positioned on a residential countertop. There may be advantages to packaging wine in a bag, such as less expensive packaging and keeping the wine fresh for a longer period of time. This new form of packaging, however, has changed the method for dispensing beverages as its use requires physically going to the box rather than just carrying a bottle to a table.

Various devices and methods for dispensing beverages from a box have been proposed in the prior art. Although assumably effective for their intended purposes, the existing devices and proposals do not provide a stand for conveniently receiving a boxed beverage that elevate the box for beverage dispensing, provide a structure for holding glassware, or provide a means for carrying the box receiving portion apart from the glassware holding portion.

Therefore, it would be desirable to have a boxed beverage stand that provides a user-friendly product for dispensing a boxed beverage from an elevated position having a structure for storing glassware therein and that overcomes the limitations of the prior art.

### SUMMARY OF THE INVENTION

A boxed beverage stand for use with a boxed beverage having a container portion and a valve includes a lower portion having a plurality of legs, a top end, and an open area; the plurality of legs elevating the top end above the open area. The stand includes a plurality of rails adjacent the lower portion top end forming a channel for receiving a glass. An upper portion is configured complementary to the lower portion top end for being selectively received atop the lower portion top end. The upper portion includes a floor, opposed sidewalls extending upwardly from the floor, a front wall extending upwardly from the floor, and a rear wall extending upwardly from the floor and that define a receiving area configured to receive the boxed beverage container portion. The front wall includes a vertical passage for the boxed beverage valve to pass through while the boxed beverage container portion is positioned in the receiving area. A handle is coupled to or formed by the upper portion for transporting the upper portion.

Therefore, a general object of this invention is to provide a stand for holding a boxed beverage.

Another object of this invention is to provide a stand, as aforesaid, having a lower portion configured to hold glassware.

Still another object of this invention is to provide a stand, as aforesaid, having an upper portion configured to be selectively separated from the lower portion and to be carried.

Yet another object of this invention is to provide a stand, as aforesaid, that elevates a boxed beverage on a countertop for easier dispensing of the beverage.

A further object of this invention is to provide a stand, as aforesaid, that is economical to manufacture and convenient to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a boxed beverage stand according to a preferred embodiment of the present invention;

FIG. 2 is a front view of the boxed beverage stand as in FIG. 1;

FIG. 3 is a perspective view of the boxed beverage stand as in FIG. 1 with an upper portion removed from a lower portion; and

FIG. 4 is an exploded view of the upper portion of the boxed beverage stand as in FIG. 3.

### DESCRIPTION OF THE PREFERRED EMBODIMENT

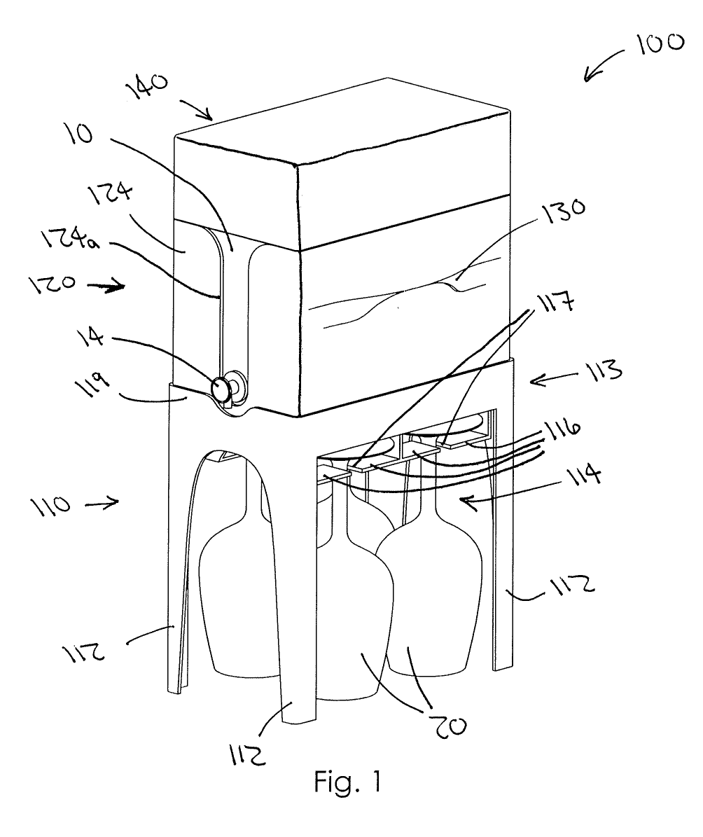

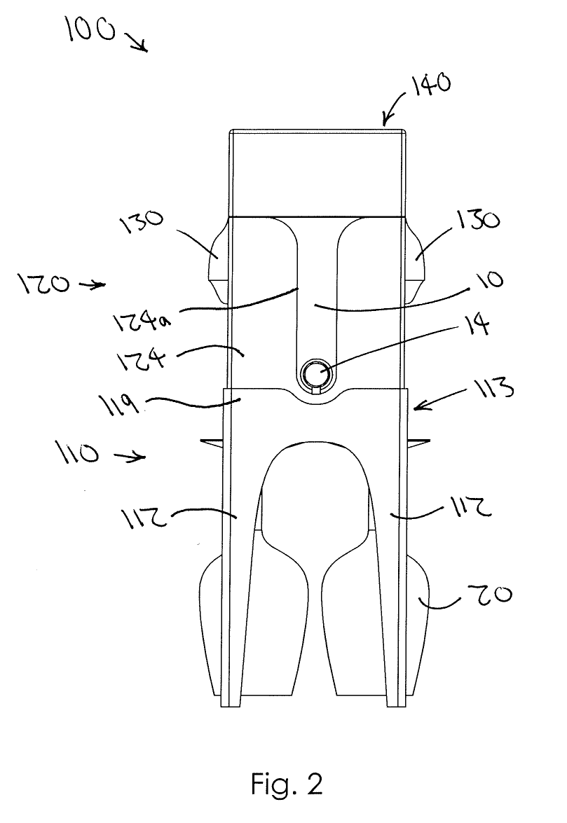

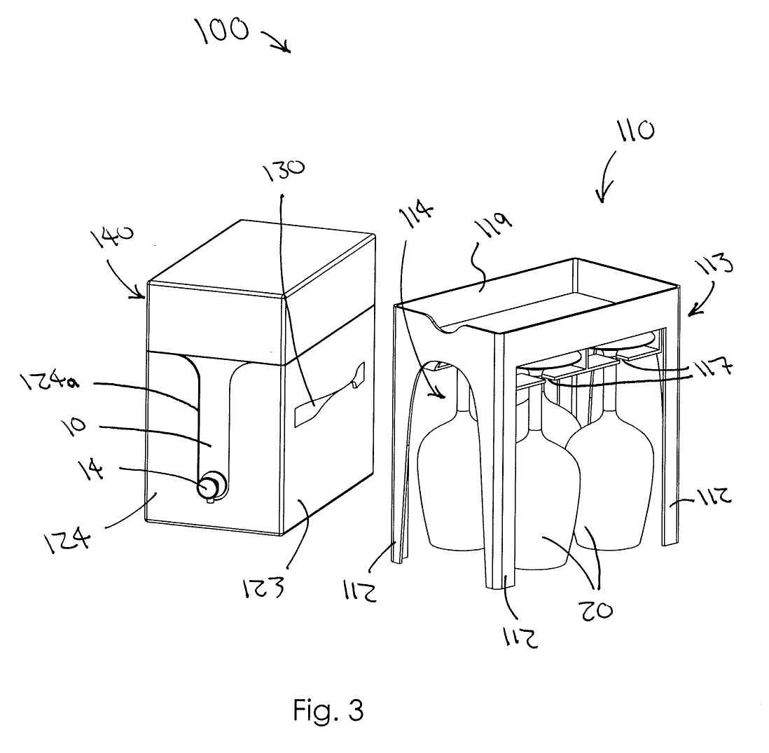

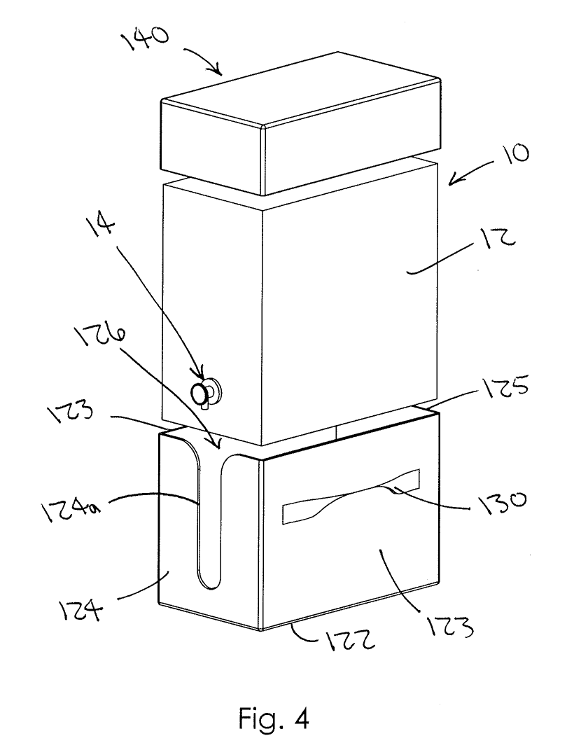

A boxed beverage stand 100 will now be described in detail with reference to FIG. 1 through FIG. 4 of the accompanying drawings. More particularly, a boxed beverage stand 100 of one embodiment includes separable lower and upper portions 110, 120 and is for use with a boxed beverage 10 and at least one glass 20 (e.g., a wine glass). As shown in FIG. 4, the boxed beverage 10 has a container portion 12 and a valve 14 for selectively releasing the contents of the container portion. The boxed beverage 10 may be, for example, boxed wine.

As shown in FIG. 1 through FIG. 3, the lower portion 110 has a plurality of legs 112, a top end 113, and an open area 114. The legs 112 elevate the top end 113 above the open area 114. Means are included, such as adjacent the top end 113, for selectively receiving the glass 20 in an inverted configuration to maintain the glass 20 in the open area 114. For example, a plurality of rails 116 separated apart from one another may form at least one channel 117 for receiving a portion of the glass 20. In some embodiments, the glass 20 may be suspended as well as inverted.

The upper portion 120 (FIGS. 1 through 4) is configured complementary to the lower portion top end 113 such that the upper portion 120 may be selectively received atop the lower portion 110. In addition to the upper portion 120 being sized and shaped to sit atop the lower portion 110, the lower portion top end 113 may define a lip 119 configured to restrict the upper portion 120 from sliding off the lower portion 110 when the upper portion 120 is received atop the lower portion 110.

As shown in FIG. 4, the upper portion 120 has a floor 122, opposed sidewalls 123 extending upwardly from the floor 122, a front wall 124 extending upwardly from the floor 122, and a rear wall 125 extending upwardly from the floor 122. The floor 122, the opposed sidewalls 123, and the front and rear walls 124, 125 collectively define a receiving area 126 configured (i.e., sized and shaped) to receive the boxed beverage container portion 12. The front wall 124 has a generally vertical passage 124a configured for the boxed beverage valve 14 to pass through while the boxed beverage container portion 12 is positioned in, and moved to and from, the receiving area 126.

At least one handle 130 may be coupled to or formed by the upper portion 120 for transporting the upper portion 120. In some embodiments, as shown in FIG. 1 through FIG. 4, a handle 130 may be at each upper portion sidewall 123 for transporting the upper portion 120.

A lid 140 (FIG. 1 through FIG. 4) may be removably coupled to the upper portion 120 to enclose the boxed beverage container portion 12 in the receiving area 126. The upper portion 120 and the lid 140 may be insulated in some embodiments to maintain the boxed beverage container portion 12 at a desired temperature for extended periods of time.

In use, the glasses 20 are received by the rails 116 and stored in the open area 114 (FIG. 1). The boxed beverage 10 may be placed in the receiving area 126 of the upper portion 120 and stored (along with the upper portion 120) in a refrigerator or other temperature-adjustable area, either with or without the lid 140, or the boxed beverage may simply be placed in the receiving area 126 for transporting the boxed beverage 10 from a storage location to a serving location without being refrigerated. Regardless, the handles 130 may be held to carry the upper portion 120 (and the boxed beverage 10 in the receiving area 126) to the lower portion 110, and the upper portion 120 (and the boxed beverage 10 in the receiving area 126) may be placed atop the lower portion 110. The lip 119 may restrict the upper portion 120 (and the boxed beverage in the receiving area 126) from sliding off the lower portion 110. The glasses 20 may be removed as desired by simply sliding the glasses 20 along the channel 117, the glasses 20 may respectively be placed lowerly adjacent the valve 14, and the contents of the boxed beverage container portion 12 may be dispensed into the glasses 20 through the valve 14.

It is understood that while certain forms of this invention have been illustrated and described, it is not limited thereto except insofar as such limitations are included in the following claims and allowable functional equivalents thereof.

1. A boxed beverage stand for use with a boxed beverage and at least one glass, said boxed beverage having a container portion and a valve for selectively releasing contents of said container portion, said boxed beverage stand comprising:
a lower portion having a plurality of legs, a top end, and an open area;
wherein said plurality of legs elevates said top end above said open area;
means adjacent said lower portion top end for selectively receiving said glass in an inverted configuration and thereby maintaining said glass in said open area;
an upper portion configured complementary to said lower portion top end such that said upper portion is selectively received atop said lower portion top end;
wherein:
said upper portion having a floor, opposed sidewalls extends upwardly from said floor, a front wall extends upwardly from said floor, and a rear wall extends upwardly from said floor;
said floor, said front and rear walls, and said opposed sidewalls collectively defines a receiving area configured to receive said boxed beverage container portion;
said front wall includes a generally vertical passage configured for said boxed beverage valve to pass through when said boxed beverage container portion is positioned in said receiving area; and
at least one handle coupled to or formed by said upper portion for transporting said upper portion.

2. The boxed beverage stand of claim 1, wherein said means comprises a plurality of rails separated apart from one another to form at least one channel for receiving said glass in said inverted configuration.

3. The boxed beverage stand of claim 2, further comprising a lid removably coupled to said upper portion to enclose said boxed beverage container portion in said receiving area.

4. The boxed beverage stand of claim 3, wherein said lower portion top end defines a lip configured to restrict said upper portion from sliding off said lower portion when said upper portion is received atop said lower portion.

5. The boxed beverage stand of claim 1, further comprising a lid removably coupled to said upper portion to enclose said boxed beverage container portion in said receiving area.

6. The boxed beverage stand of claim 1, wherein said lower portion top end defines a lip configured to restrict said upper portion from sliding off said lower portion when said upper portion is received atop said lower portion.

7. A boxed beverage stand for use with a boxed beverage and at least one glass, said boxed beverage having a container portion and a valve for selectively releasing contents of said container portion, said boxed beverage stand comprising:
a lower portion having a plurality of legs, a top end, and an open area; said plurality of legs elevating said top end above said open area;
a plurality of rails separated apart from one another to form at least one channel for selectively receiving said glass in a suspended inverted configuration and thereby maintaining said glass in said open area;
an upper portion configured complementary to said lower portion top end such that said upper portion is selectively received atop said lower portion; said upper portion having a floor, opposed sidewalls extending upwardly from said floor, a front wall extending upwardly from said floor, and a rear wall extending upwardly from said floor; said floor, said front and rear walls, and said opposed sidewalls collectively defining a receiving area configured to receive said boxed beverage container portion; said front wall having a generally vertical passage configured for said boxed beverage valve to pass through while said boxed beverage container portion is positioned in said receiving area; and
a handle at each said upper portion sidewall for transporting said upper portion.

8. The boxed beverage stand of claim 7, further comprising a lid removably coupled to said upper portion to enclose said boxed beverage container portion in said receiving area.

9. The boxed beverage stand of claim 8, wherein said lower portion top end defines a lip configured to restrict said upper portion from sliding off said lower portion when said upper portion is received atop said lower portion.

10. The boxed beverage stand of claim 7, wherein said lower portion top end defines a lip configured to restrict said upper portion from sliding off said lower portion when said upper portion is received atop said lower portion.
